(19) United States
(12) Patent Application Publication
(10) Pub. No.: US 2026/0002001 A1
(43) Pub. Date: Jan. 1, 2026

(54) COMPOSITION AND POLYMER

(71) Applicant: TOKYO OHKA KOGYO CO., LTD., Kawasaki-shi (JP)

(72) Inventors: Ryutaro Sugawara, Kawasaki-shi (JP); Takuya Uehara, Kawasaki-shi (JP); Saburo Kobayashi, Kawasaki-shi (JP)

(21) Appl. No.: 19/249,643

(22) Filed: Jun. 25, 2025

(30) Foreign Application Priority Data
Jun. 27, 2024 (JP) 2024-104099

(51) Int. Cl. C08G 81/02

(52) U.S. Cl. CPC C08G 81/027

(57) ABSTRACT

A composition for selective modification of a base material having a surface containing two or more regions that are different in material from each other, the composition including a polymer and a solvent. The polymer has a block (A1) and a block (A2; the block (A1) has a constituent unit derived from at least one of styrene, a styrene derivative, and an (α-substituted) acrylate; the block (A2) having two or more groups represented by the following formula (1)

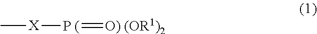

in which X represents a single bond or an oxygen atom, and R¹ represents an alkyl group, and the group represented by the formula (1) is bonded to a carbon atom.

### RELATED APPLICATION

This application claims priority to Japanese Patent Application No. 2024-104099, filed Jun. 27, 2024, the entire content of which is incorporated herein by reference.

### BACKGROUND OF THE INVENTION

### Field of the Invention

The present invention relates to a composition and a polymer for selective modification of a base material having a surface containing two or more regions that are different in material from each other.

### Related Art

As semiconductor devices are further miniaturized, a technique for forming a fine pattern with a width of 30 nm is required. In conventional lithography methods, however, it is technically difficult to form a finer pattern due to an optical factor or the like.

Therefore, a technique has been developed for forming a finer pattern by utilizing a phase separation structure formed by self-assembly of a block copolymer having blocks that are incompatible with each other and are bonded to each other. For example, Patent Document 1 proposes a base agent containing a polymer compound in which a first polymer block and a second polymer block are bonded via a linking group containing a substrate adhesion group, as a base agent used for phase-separating a layer containing a block copolymer and modifying a substrate surface.

In addition, a method has been studied for selectively modifying a base material with the surface having two or more fine regions that are different in material from each other. This selective modification method requires a material capable of modifying a surface region easily and highly selectively, and thus, various materials have been studied.
Patent Document 1: Japanese Unexamined Patent Application, Publication No. 2018-159061

### SUMMARY OF THE INVENTION

In the selective modification method, a polymer brush using a polymer having an adsorptive terminal group has been developed. However, a base agent that has good base material selectivity and is capable of forming a polymer brush having good brush density has not been known yet.

In addition, after the selective modification, a high-temperature treatment such as an annealing treatment may be performed at the time of self-assembly of the block copolymer. Accordingly, a base agent capable of forming a polymer brush is also required to have good heat resistance.

The present invention has been made in view of the above circumstances, and an object of the present invention is to provide a composition and a polymer capable of forming a polymer brush exhibiting good base material selectivity and having good brush density and heat resistance.

In order to solve the above problems, the present inventors have conducted intensive studies, and as a result, have found that the above problems can be solved by using a composition containing a predetermined polymer (A), and have completed the present invention. Specifically, the present invention provides the following.

A first aspect of the present invention relates to a composition for selective modification of a base material having a surface containing two or more regions that are different in material from each other,
the composition including a polymer (A) and a solvent (S),
   in which the polymer (A) has a block (A1) and a block (A2),
the block (A1) has a constituent unit derived from at least one selected from the group consisting of styrene, a styrene derivative, and an (α-substituted) acrylate,
the block (A2) has two or more groups represented by the following formula (1):

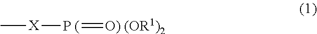

in which, in the formula (1), X represents a single bond or an oxygen atom, and R¹ represents an alkyl group, and
the group represented by the formula (1) is bonded to a carbon atom.

A second aspect of the present invention relates to a polymer having a block (A1) and a block (A2),
in which the block (A1) has a constituent unit derived from at least one selected from the group consisting of styrene, a styrene derivative, and an (α-substituted) acrylate,
the block (A2) has two or more groups represented by the following formula (1):

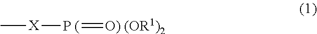

in which, in the formula (1), X represents a single bond or an oxygen atom, and R¹ represents an alkyl group, and
the group represented by the formula (1) is a polymer bonded to a carbon atom.

According to the present invention, it is possible to provide a composition and a polymer capable of forming a polymer brush exhibiting good base material selectivity and having good brush density and heat resistance.

### DETAILED DESCRIPTION OF THE INVENTION

Hereinafter, embodiments of the present invention will be described in detail, but the present invention is not limited to the following embodiments at all, and can be carried out with appropriate modifications within the scope of the object of the present invention.

### <<Compositions>>

The composition is used for selective modification of a base material having a surface containing two or more regions that are different in material from each other, and the composition contains a polymer (A) and a solvent (S). The polymer (A) has a block (A1) and a block (A2). The block (A1) has a constituent unit derived from at least one selected from the group consisting of styrene, a styrene derivative, and an (α-substituted) acrylate. The block (A2) has two or more groups represented by the following formula (1). The group represented by the formula (1) is bonded to a carbon atom.

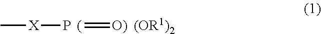

in which, in the formula (1), X represents a single bond or an oxygen atom, and R¹ represents an alkyl group.

The surface of the base material preferably comprises a region (hereinafter, also referred to as “region (I)”.) including a metal, and more preferably comprises a region (I) and a region (hereinafter, also referred to as “region (II)”) substantially composed of a nonmetal.

The metal is not particularly limited as long as it is a metallic element. Silicon is a nonmetal and does not fall under the metal. Examples of the metal include copper, iron, zinc, cobalt, aluminum, tin, tungsten, zirconium, titanium, tantalum, germanium, molybdenum, ruthenium, gold, silver, platinum, palladium, nickel, etc. Among these, copper, cobalt, tungsten, or tantalum is preferable.

Examples of a form of the metal contained in the region (I) include an elemental metal, an alloy, a conductive nitride, a metal oxide, a silicide, etc.

Examples of elemental metals include copper, iron, cobalt, tungsten, tantalum, etc. Examples of the alloy include a nickel-copper alloy, a cobalt-nickel alloy, a gold-silver alloy, etc. Examples of the conductive nitride include tantalum nitride, titanium nitride, iron nitride, aluminum nitride, etc. Examples of the metal oxide include tantalum oxide, aluminum oxide, iron oxide, copper oxide, etc. Examples of the silicide include iron silicide, molybdenum silicide, etc.

Among these, an elemental metal, an alloy, a conductive nitride, or a silicide is preferable, an elemental metal or a conductive nitride is more preferable, and elemental copper, elemental cobalt, elemental tungsten, elemental tantalum, or tantalum nitride is further preferable.

Examples of a form of a nonmetal in the region (II) include, for example, elemental nonmetal, an oxide of a nonmetal, a nitride of a nonmetal, an oxide-nitride of a nonmetal, etc.

Examples of elemental nonmetals include elemental silicon and elemental carbon. Examples of the oxide of a nonmetal include silicon oxide, etc. Examples of the nitride of a nonmetal include SiNₓ and Si₃N₄. Examples of the oxide-nitride of a nonmetal include SiON, etc.

Among these, an oxide of a nonmetal or a nitride of a nonmetal is preferable, and an oxide of a nonmetal is more preferable.

The existence shape of the region (I) and/or the region (II) on the surface of the base material is not particularly limited, and examples thereof include a planar shape, a dot shape, a stripe shape, etc. in a plan view. The size of the region (I) and the region (II) is not particularly limited, and a region having a desired size can be appropriately used. The shape of the base material is not particularly limited, and may be a desired shape such as a plate shape (substrate), a spherical shape, etc.

### <Polymer (A)>

The polymer (A) has block (A1) and block (A2).

### (Block (A1))

The block (A1) has a constituent unit derived from at least one selected from the group consisting of styrene, styrene derivatives, and (α-substituted) acrylates.

Examples of the styrene derivatives include compounds in which a hydrogen atom bonded to a carbon atom at an α-position of styrene is substituted with a substituent, such as an alkyl group having 1 or more and 10 or less carbon atoms; compounds in which a hydrogen atom of a phenyl group of the styrene is substituted with a substituent, such as an alkyl group having 1 or more and 10 or less carbon atoms, an alkoxy group having 1 or more and 10 or less carbon atoms, a hydroxy group, a nitro group, a halogen atom, or an acetoxy group, etc.; or the like. The styrene derivatives include α-methylstyrene, 2-methylstyrene, 3-methylstyrene, 4-methylstyrene, 4-tert-butylstyrene, 4-n-octylstyrene, 2,4,6-trimethylstyrene, 4-methoxystyrene, 4-tert-butoxystyrene, 4-hydroxystyrene, 4-nitrostyrene, 3-nitrostyrene, 4-chlorostyrene, 4 fluorostyrene, 4-acetoxystyrene, 4-chloromethylstyrene, etc.

The (α-substituted) acrylates are acrylates or acrylic acid derivatives in which a hydrogen atom bonded to the carbon atom at the α-position in the acrylate is substituted with a substituent. Substituents in the (α-substituted) acrylates include alkyl groups having 1 or more and 5 or less carbon atoms and halogenated alkyl groups having 1 or more and 5 or less carbon atoms. Among these, the alkyl groups having 1 or more and 5 or less carbon atoms are preferred, and a methyl group is more preferred.

Preferable examples of the (α-substituted) acrylates include (α-substituted) alkyl acrylates, (α-substituted) cycloalkyl acrylates, (α-substituted) hydroxyalkyl acrylates, (α-substituted) aryl acrylates, (α-substituted) aralkyl acrylates, (α-substituted) epoxyalkyl acrylates, (α-substituted) epoxycycloalkyl acrylates. Among these (α-substituted) acrylates, (α-substituted) alkyl acrylates are preferred. In the (α-substituted) alkyl acrylates, the number of carbon atoms of the alkyl group included in the alkyl ester is preferably 1 or more and 10 or less, and more preferably 1 or more and 5 or less. Specifically, the (α-substituted) alkyl acrylates include acrylates, such as methyl acrylate, ethyl acrylate, propyl acrylate, a n-butyl acrylate, tert-butyl acrylate, cyclohexyl acrylate, octyl acrylate, nonyl acrylate, hydroxyethyl acrylate, hydroxypropyl acrylate, benzyl acrylate, anthracene acrylate, glycidyl acrylate, 3,4-epoxycyclohexyl methane acrylate, 3-trimethoxysilylpropyl acrylate, etc.; methacrylates, such as methyl methacrylate, ethyl methacrylate, propyl methacrylate, a n-butyl methacrylate, tert-butyl methacrylate, cyclohexyl methacrylate, octyl methacrylate, nonyl methacrylate, hydroxyethyl methacrylate, hydroxypropyl methacrylate, benzyl methacrylate, anthracene methacrylate, glycidyl methacrylate, 3,4-epoxycyclohexyl methane methacrylate, 3-trimethoxysilylpropyl methacrylate, etc.; or the like.

Among the above, the alkyl acrylates or alkyl methacrylates are preferred as the (α-substituted) acrylates, and methyl acrylate, ethyl acrylate, tert-butyl acrylate, methyl methacrylate, ethyl methacrylate, or tert-butyl methacrylate is more preferred, and methyl methacrylate is even more preferred.

The block (A1) preferably has a constituent unit derived from styrene or methyl methacrylate.

A molar ratio of the total constituent units of the block (A1) with respect to the total constituent units of the polymer (A) is preferably 40 mol % or more, more preferably 50 mol % or more, even more preferably 60 mol % or more, particularly preferably 70 mol % or more, and most preferably 80 mol % or more. The ratio is preferably 99 mol % or less, and more preferably 95 mol % or less. Within the above-mentioned numerical value range, a good brush density is easily obtained.

### (Block A2)

The block A2 has two or more groups represented by the following formula (1). The group represented by the formula (1) is bonded to a carbon atom:

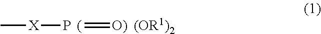

in which, in the formula (1), X represents a single bond or an oxygen atom, and R¹ represents an alkyl group. A plurality of R¹ may the same or different from each other.

X preferably is an oxygen atom from the viewpoint of heat resistance.

A number of carbon atoms of an alkyl group as R¹ is preferably 1 or more and 10 or less, more preferably 1 or more and 5 or less, and even more preferably 1 or more and 3 or less. The alkyl group as R¹ may be linear or branched, but preferably is linear. Examples of the linear alkyl group include a methyl group, an ethyl group, a n-propyl group, a n-butyl group, a n-pentyl group, etc. Examples of the branched alkyl group include an isopropyl group, a sec-butyl group, an isobutyl group, a tert-butyl group, a neopentyl group, an isopentyl group, a sec-pentyl group, a 3-pentyl group, a tert-pentyl group, etc.

The block (A2) may or may not be an oligomer or a polymer including a plurality of constituent units, but preferably is an oligomer or a polymer.

The block (A2) preferably has two or more constituent units having a group represented by the formula (1). Note that a number of these constituent units does not represent a number of types of the constituent units, but a number of constituent units that are present in the block (A2) and that have the group represented by the formula (1). The two or more constituent units having a group represented by the formula (1) may consist of the same types of constituent unit, or may consist of two or more types of constituent unit. In the constituent unit having a group represented by the formula (1), a number of the groups represented by the formula (1) is not particularly limited, and may be, for example, 1 or 2, or may be 1.

The block (A2) preferably has the group represented by the formula (1) and two or more constituent units derived from a compound having an ethylenically unsaturated group.

The ethylenically unsaturated group is a group having an ethylenically unsaturated double bond. The ethylenically unsaturated group is not particularly limited, and examples thereof include alkenyl groups such as a vinyl group, a 1-propenyl group, a 2-n-propenyl group (an allyl group), a 1-n-butenyl group, a 2-n-butenyl, a 3-n-butenyl group, etc.; (meth)acryloyl group-containing groups such as a (meth)acryloyl group, a (meth)acryloyloxy group, a (meth)acryloylamino group, etc.; or the like. Among these, the (meth)acryloyl group-containing group is preferable, and the (meth)acryloyloxy group is preferable.

The block (A2) preferably has two or more constituent units derived from an (α-substituted) acrylate having a group represented by the following formula (1). Substituents in the (α-substituted) acrylates are the same as substituents in the (α-substituted) acrylates in the block (A1).

As a constituent unit derived from the (α-substituted) acrylates having a group represented by the formula (1), a constituent unit represented by the following formula (2) is preferable.

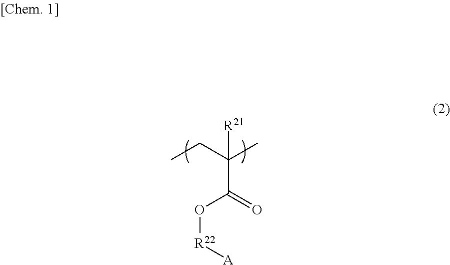

wherein, in the formula (2), R²¹ is a hydrogen atom, an alkyl group having 1 or more and 5 or less carbon atoms or a halogenated alkyl group having 1 or more and 5 or less carbon atoms, and R²² is an alkylene group which may have a substituent, and A is a group represented by the formula (1).

Examples of the alkyl groups having 1 or more and 5 or less carbon atoms as R²¹ include a methyl group, an ethyl group, a n-propyl group, an isopropyl group, a n-butyl group, a sec-butyl group, an isobutyl group, a tert-butyl group, a n-pentyl group, a neopentyl group, an isopentyl group, a sec-pentyl group, a 3-pentyl group, a tert-pentyl group, etc.

The halogenated alkyl groups having 1 or more and 5 or less carbon atoms are groups in which some or all of the hydrogen atoms of an alkyl group having 1 or more and 5 or less carbon atoms are substituted with a halogen atom(s). As the halogen atom, a fluorine atom is particularly preferable.

R²¹ preferably is a hydrogen atom or an alkyl group having 1 or more and 5 or less carbon atoms and a methyl group is more preferable.

A number of carbon atoms of the alkylene group as R²² preferably is 1 or more and 10 or less, and more preferably is 1 or more and 8 or less.

The alkylene group as R²² may be linear or branched, but more preferably is linear.

Examples of the linear alkylene group include a methylene group [—CH₂—], an ethylene group [—(CH₂)₂—], a trimethylene group [—(CH₂)₃—], a tetramethylene group [—(CH₂)₄—], a pentamethylene group [—(CH₂)₅—], a hexamethylene group [—(CH₂)₆]—, etc.

Examples of the branched alkylene groups include alkylalkylene groups, etc., such as alkylmethylene groups such as —CH(CH₃)—, —CH(CH₂CH₃)—, —C(CH₃)₂—, —C(CH₃) (CH₂CH₃)—, —C(CH₃) (CH₂CH₂CH₃)—, —C(CH₂CH₃)₂—, etc.; alkylethylene groups such as —CH(CH₃) CH₂—, —CH(CH₃) CH(CH₃)—, —C(CH₃)₂CH₂—, —CH(CH₂CH₃) CH₂—, —C(CH₂CH₃)₂—CH₂—, etc.; alkyltrimethylene groups such as —CH(CH₃)CH₂CH₂—, —CH₂CH(CH₃)CH₂—, etc.; alkyltetramethylene groups such as —CH(CH₃)CH₂CH₂CH₂—, —CH₂CH(CH₃)CH₂CH₂—, etc.; or the like. As an alkyl group in the alkylalkylene group, a linear alkyl group having 1 or more and 5 or less carbon atoms is preferable.

Examples of a substituent that the alkylene group as R²² may have include a halogen atom; a halogenated alkyl group having 1 or more and 5 or less carbon atoms, the halogenated alkyl group being substituted with at least one halogen atom; or the like.

Below, examples of the constituent units derived from the (α-substitute) acrylates having a group represented by the formula (1) will be presented.

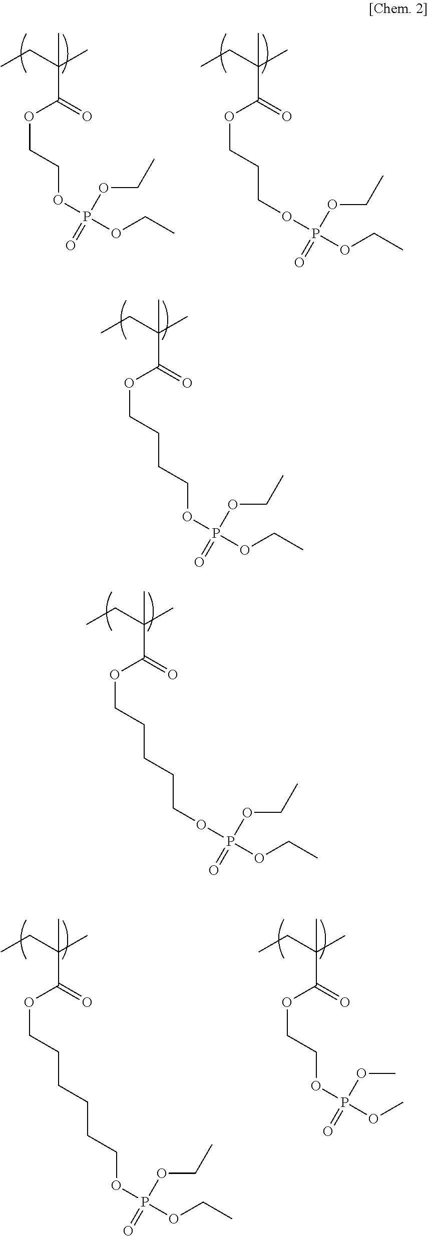

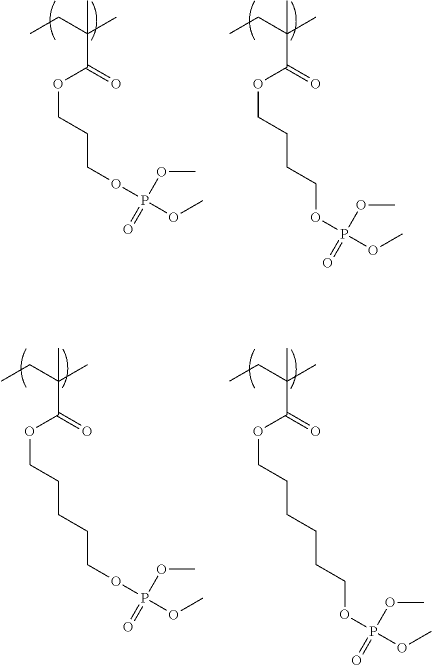

A molar ratio of the total constituent units of the block (A2) with respect to the total constituent units of the polymer (A) is preferably greater than 0 molo, more preferably greater than 1 mol %, and even more preferably greater than 5 mol %. The ratio is preferably 60 mol % or less, more preferably 50 mol % or less, even more preferably 40 mol % or less, particularly preferably 30 mol % or less, and most preferably 20 mol % or less. Within the above-mentioned numerical value range, a good brush density is easily obtained.

The polymer (A) may have a block other than the block (A1) or the block (A2), but preferably does not have another block.

When the polymer (A) has another block, the block (A2) preferably is not present between the blocks other than the block (A2) (the block (A2) is preferably located at one end of the main chain of the polymer (A)).

A sum of the molar ratio of the total constituent units of the block (A1) with respect to the total constituent units of the polymer (A) and the molar ratio of the total constituent units of the block (A2) with respect to the total constituent units of the polymer (A) is preferably 70 mol % or more, more preferably 90 mol % or more, and even more preferably 95 mol % or more, and may be 100 mol %.

A number average molecular weight (Mn) of the polymer (A) preferably is 30,000 or less, more preferably 20,000 or less, even more preferably 10,000 or less, and particularly preferably 8,000 or less. The Mn is preferably 1,000 or more, more preferably 2,000 or more, and even more preferably 3,000 or more. Within the above-mentioned numerical value range, a good brush density is easily obtained. In the present description, the “number average molecular weight” (Mn) is a number average molecular weight in terms of standard polystyrene determined by size exclusion chromatography (SEC) measurement.

A method for producing the polymer (A) is not particularly limited. For example, when the block (A2) is an oligomer or a polymer, the polymer (A) can be produced by polymerizing a monomer of the constituent unit constituting the block (A1) and a monomer of the constituent unit constituting the block (A2) by a conventionally known polymerization method.

### <Solvent (S)>

The composition includes a solvent (S). As the solvent (S), an organic solvent can be mentioned. The organic solvent can be one that can dissolve components to be used to form a homogeneous solution. Any organic solvent selected from organic solvents that are conventionally known as solvents for compositions including a resin as a main component can be used.

Examples of the organic solvents include lactones such as γ-butyrolactone; ketones such as acetone, methyl ethyl ketone, cyclohexanone, methyl-n-pentyl ketone, methyl isopentyl ketone, 2-heptanone, etc.; polyhydric alcohols such as ethylene glycol, diethylene glycol, propylene glycol, dipropylene glycol, etc.; monoacetates of polyhydric alcohols such as ethylene glycol monoacetate, diethylene glycol monoacetate, propylene glycol monoacetate, or dipropylene glycol monoacetate, etc.; derivatives of polyhydric alcohols such as compounds having an ether bond such as monoalkyl ethers such as a monomethyl ether, a monoethyl ether, a monopropyl ether, a monobutyl ether, or the like of the polyhydric alcohols or monoacetates of the polyhydric alcohols or monophenyl ethers of the polyhydric alcohols or monoacetates of the polyhydric alcohols [among these, propylene glycol monomethyl ether acetate (PGMEA) and propylene glycol monomethyl ether (PGME) are preferred]; cyclic ethers such as dioxane; esters other than monoacetates of polyhydric alcohols and the derivatives of the polyhydric alcohols mentioned above, such as methyl lactate, ethyl lactate (EL), methyl acetate, ethyl acetate, butyl acetate, methyl pyruvate, ethyl pyruvate, methyl methoxypropionate, ethyl ethoxypropionate, etc.; aromatic organic solvents such as anisole, ethyl benzyl ether, cresyl methyl ether, diphenyl ether, dibenzyl ether, phenethol, butyl phenyl ether, ethyl benzene, diethyl benzene, pentylbenzene, isopropylbenzene, toluene, xylene, cymene, mesitylene, etc. or the like. The organic solvent components may be used alone or as a mixed solvent of two or more types. Among these, propylene glycol monomethyl ether acetate (PGMEA), propylene glycol monomethyl ether (PGME), cyclohexanone, or ethyl lactate (EL) are preferred.

A content of the solvent contained in the composition is not particularly limited. The solvent concentration is appropriately set such that the composition has an applicable concentration depending upon the coated film thickness. The solvent is generally used so that the composition has a solid content of 0.2% by mass or more and 70% by mass or less, preferably 0.2% by mass or more and 50% by mass or less.

### <Other Components>

Further as desired, the composition may contain a miscible additive, for example, an additive resin for improving performance of a lower layer film, a surfactant for improving applicability, a dissolution inhibiting agent, a plasticizer, a stabilizer, a colorant, an anti-halation agent, a dye, a sensitizer, a base-proliferating agent, a basic compound, etc.

### <<Polymer>>

The polymer has block (A1) and block (A2). The block (A1) has a constituent unit derived from at least one selected from the group consisting of styrene, a styrene derivative, and an (α-substituted) acrylate. The block (A2) has two or more groups represented by the following formula (1). The group represented by the formula (1) is bonded to a carbon atom:

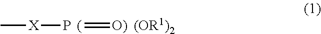

in which, in the formula (1), X represents a single bond or an oxygen atom, and R¹ is an alkyl group.

Details and/or preferred embodiments of the polymer are the same as those of the polymer (A) in the composition described above.

As described above, the following aspects [1] to [7] are provided by the present inventors.

[1]A composition for selective modification of a base material having a surface containing two or more regions that are different in material from each other,
the composition including a polymer (A) and a solvent (S)
in which the polymer (A) has a block (A1) and a block (A2),
the block (A1) has a constituent unit derived from at least one selected from the group consisting of styrene, a styrene derivative, and an (α-substituted) acrylate,
the block (A2) has two or more groups represented by the following formula (1):

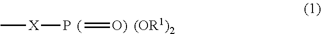

in which, in the formula (1), X represents a single bond or an oxygen atom, and R¹ represents an alkyl group, and
the group represented by the formula (1) is bonded to a carbon atom.
   [2] The composition as described in aspect [1], in which the block (A2) has two or more constituent units derived from an (α-substituted) acrylate having a group represented by the formula (1), and
a molar ratio of the total constituent units of the block (A2) is greater than 0 mol % and 50 mol % or less with respect to the total constituent units of the polymer (A).
   [3] The composition as described in aspect {2}, in which a molar ratio of the total constituent units of the block (A2) is greater than 0 mol % and 20 mol % or less with respect to the total constituent units of the polymer (A).
   [4] The composition as described in any one of aspects [1] to [3], in which the polymer (A) has a number average molecular weight of 2,000 or more and 10,000 or less.
   [5] The composition as described in any one of aspects [1] to [4], in which the block (A1) has a constituent unit derived from styrene or methyl methacrylate.
   [6]A polymer having a block (A1) and a block (A2),
in which the block (A1) has a constituent unit derived from at least one selected from the group consisting of styrene, a styrene derivative, and an (α-substituted) acrylate,
the block (A2) has two or more groups represented by the following formula (1):

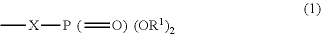

in which, in the formula (1), X represents a single bond or an oxygen atom, and R¹ represents an alkyl group, and
the group represented by the formula (1) is bonded to a carbon atom.
   [7] The polymer as described in aspect [6], in which the block (A2) has two or more constituent units derived from an (α-substituted) acrylate having a group represented by the formula (1), and
a molar ratio of the total constituent units of the block (A2) is greater than 0 mol % and 50 mol % or less with respect to the total constituent units of the polymer (A).

### Examples

The present invention will be described in more detail based on Examples, but the present invention is not limited to these Examples.

Hereinafter, polymers used in the Examples and Comparative Examples will be described.

A-1 to A-5: polymers represented by the following formulae. In each formula, x and y at the lower right of parentheses ( ) represent each molar ratio, which is a number of moles (mol %) of the respective constituent units with respect to the number of moles of the total constituent units. A-1 has a number average molecular weight (Mn) of 5,000, x of 50 mol %, and y of 50 mol %. A-2 has a number average molecular weight (Mn) of 5,000, x of 80 mol %, and y of 20 mol %. A-3 has a number average molecular weight (Mn) of 5,000, x of 90 mol %, and y of 10 mol %. A-4 has a number average molecular weight (Mn) of 10,000, x of 90 mol %, and y of 10 mol %. A-5 has a number average molecular weight (Mn) of 15,000, x of 90 mol %, and y of 10 mol %.

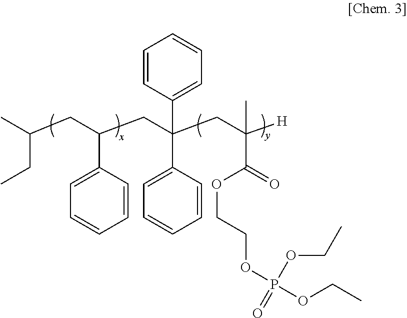

A-6 to A-10: polymers represented by the following formulae. In each formula, x and y at the lower right of parentheses ( ) each represent a molar ratio, which is a number of moles (mol %) of the respective constituent units with respect to the number of moles of the total constituent units. A-6 has a number average molecular weight (Mn) of 5,000, x of 50 mol %, and y of 50 mol %. A-7 has a number average molecular weight (Mn) of 5,000, x of 80 mol %, and y of 20 mol %. A-8 has a number average molecular weight (Mn) of 5,000, x of 90 mol %, and y of 10 mol %. A-9 has a number average molecular weight (Mn) of 10,000, x of 90 mol %, and y of 10 mol %. A-10 has a number average molecular weight (Mn) of 15,000, x of 90 mol %, and y of 10 mol %.

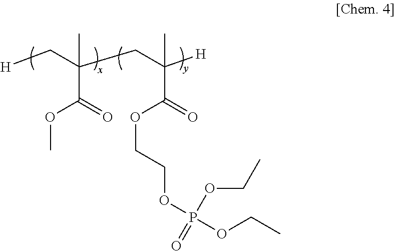

A-11: a polymer represented by the following formula. In the formula, x and y at the lower right of parentheses ( ) represent each molar ratio, which is a number of moles (mol %) of the respective constituent units with respect to the number of moles of the total constituent units. A-11 has a number average molecular weight (Mn) of 5,000, x of 90 mol %, and y of 10 mol %.

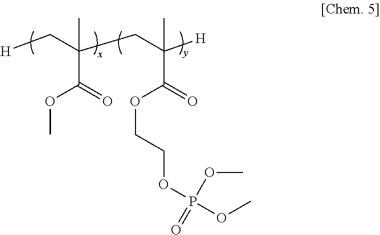

A-12: a polymer represented by the following formula. In the formula, x and y at the lower right of parentheses ( ) represent each molar ratio, which is a number of moles (mol %) of the respective constituent units with respect to the number of moles of the total constituent units. A-12 has a number average molecular weight (Mn) of 5,000, x of 90 mol %, and y of 10 mol %.

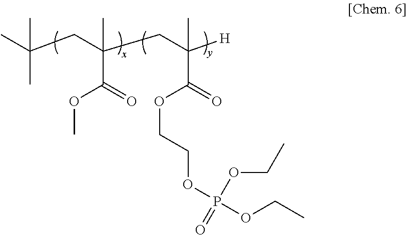

A-13: a polymer represented by the following formula. In the formula, x and y at the lower right of parentheses ( ) represent each molar ratio, which is a number of moles (mol %) of the respective constituent units with respect to the number of moles of the total constituent units. A-13 has a number average molecular weight (Mn) of 5,000, x of 90 mol %, and y of 10 mol %.

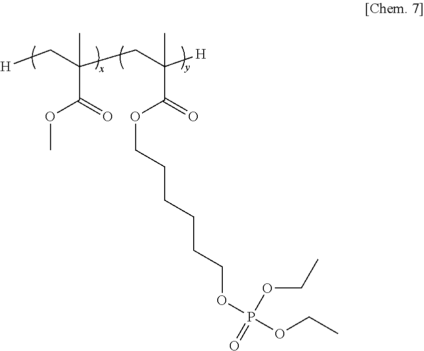

A-14 and A-15: polymers represented by the following formulae. A-14 has Mn of 10,000. A-15 has Mn of 4,700.

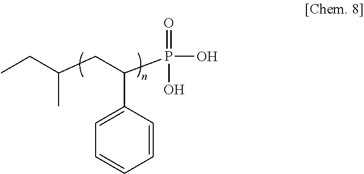

A-16: a polymer represented by the following formula. In the formula, x and y at the lower right of parentheses ( ) represent each molar ratio, which is a number of moles (mol %) of the respective constituent units with respect to the number of moles of the total constituent units. A-16 has a number average molecular weight (Mn) of 5,000, x of 90 mol %, and y of 10 mol %.

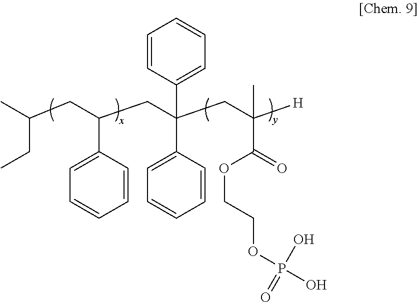

### <Preparation of Compositions>

Each polymer of the type shown in Table 1 was mixed with propylene glycol monomethyl ether acetate (PGMEA) so that the concentration is 1.0% by mass to prepare the compositions of the Examples.

### <Evaluation of Compositions>

A tungsten (w) substrate was immersed in a 0.2% by mass hydrofluoric acid, was rinsed with purified water, and dried by a nitrogen flow. A silicon oxide (SiO₂) substrate was subjected to a surface treatment, using isopropanol.

### (Formation of Films)

Each composition of the Examples was applied to a surface-treated tungsten substrate by spin coating at 1,500 rpm. Each substrate coated with the composition was baked on a hot plate at 200° C. for 5 min. in an air atmosphere. Then, the substrate was rinsed with PGMEA to remove unreacted polymer. Further, the substrate was baked at 100° C. for 1 min to remove the solvent to form a film on the tungsten substrate. Similarly, a film was also formed on the silicon oxide substrate.

### (Evaluation of Contact Angle)

By using Drop Master 700 (manufactured by Kyowa Interface Science), pure water droplets (2.0 μL) were added dropwise on the surface of each substrate having the film thereon, and the contact angle of the substrate was measured once per second, 10 times in total. The contact angle was measured at three different points on the substrate, and a total of 30 measurements were taken as the contact angle of water. As a reference example, the contact angle of the substrate before forming the film was measured in the same manner. The results are shown in Table 1.

### (Brush Density Evaluation)

The film thickness of the formed film was measured using a spectroscopic ellipsometer (M-2000 manufactured by J. A. Woollam). The results are shown in Table 1.

### (Evaluation of Brush Densities)

Based on the film thickness of the tungsten substrate, the brush density of the film (polymer brush) formed on the tungsten substrate was calculated by the following formula. The results are shown in Table 1. The density of A-1 was 1.09 g/cm³, the density of A-2 was 1.07 g/cm³, the densities of A-3 to A-5 were 1.06 g/cm³, the densities of A-6 to A-13 were 1.17 g/cm³, the densities of A-14 to A-15 were 1.05 g/cm³, and the density of A-16 was 1.17 g/cm³.

$$σ = d \times L \times NA \times {10}^{- 21} / Mn$$

[ø: brush density (number of chains/nm²), d: density of polymer (g/cm³), L: film thickness (nm), NA: Avogadro number, Mn: number average molecular weight of polymer (g/number of chains).]

### (Heat Resistance Evaluation)

The tungsten substrate on which the film was formed was baked at 280° C. for 5 minutes by a hot plate in an air atmosphere. The baked substrate was rinsed with PGMEA and further baked at 100° C. for 1 minute.

The brush density was calculated by measuring the film thickness of the substrate after these treatments.

A case where there was a change of 5% or more with respect to the brush density of the substrate before the treatment was evaluated as “B”, and a case where there was no change of 5% or more with respect to the brush density of the substrate before the treatment was evaluated as “A”. The results are shown in Table 1.

TABLE 1

| | | | Water contact | | Film | | Brush | |
|---|---|---|---|---|---|---|---|---|
| | | | angle | | thickness | | density | |
| | | | (°) | | (nm) | | (number of | Heat |
| | | Polymer | W | SiO₂ | W | SiO₂ | chains/nm²) | resistance |
| Reference Example | | — | <10 | 45 | — | — | — | — |
| Example | 1 | A-1 | 88 | 45 | 3.9 | 0.5 | 0.51 | A |
| | 2 | A-2 | 90 | 45 | 5.8 | 0.7 | 0.74 | A |
| | 3 | A-3 | 90 | 45 | 5.9 | 0.5 | 0.75 | A |
| | 4 | A-4 | 90 | 46 | 11.1 | 0.6 | 0.71 | A |
| | 5 | A-5 | 90 | 45 | 14.8 | 0.5 | 0.63 | A |
| | 6 | A-6 | 65 | 45 | 3.5 | 0.5 | 0.50 | A |
| | 7 | A-7 | 65 | 45 | 5.2 | 0.7 | 0.73 | A |
| | 8 | A-8 | 66 | 44 | 5.3 | 0.5 | 0.74 | A |
| | 9 | A-9 | 65 | 46 | 9.9 | 0.6 | 0.70 | A |
| | 10 | A-10 | 65 | 45 | 13.0 | 0.5 | 0.61 | A |
| | 11 | A-11 | 66 | 44 | 5.3 | 0.5 | 0.74 | A |
| | 12 | A-12 | 69 | 44 | 5.0 | 0.6 | 0.71 | A |
| | 13 | A-13 | 66 | 44 | 5.3 | 0.5 | 0.74 | A |
| Comparative | 1 | A-14 | 90 | 45 | 4.7 | 0.5 | 0.30 | B |
| Example | 2 | A-15 | 89 | 44 | 2.8 | 0.4 | 0.38 | B |
| | 3 | A-16 | 72 | 45 | 3.2 | 2.8 | 0.45 | B |

As shown in Table 1, in Examples 1 to 13 in which the predetermined polymer was used, it was confirmed from the change in the water contact angle with respect to the Reference Example that the selectivity to the metal surface was good. In addition, as compared with Comparative Examples 1 to 3, it was confirmed that the film thickness of the formed film was thick and the brush density was high. Further, it was confirmed that the heat resistance was good.

What is claimed is:

1. A composition for selective modification of a base material having a surface containing two or more regions that are different in material from each other, comprising:
a polymer (A) having a block (A1), a block (A2) and a solvent (S),
wherein the block (A1) has a constituent unit derived from at least one selected from the group consisting of styrene, a styrene derivative, and an (α-substituted) acrylate,
the block (A2) has two or more groups represented by the following formula (1): 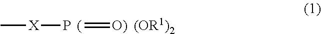
wherein, in the formula (1), X represents a single bond or an oxygen atom, and R¹ represents an alkyl group, and
wherein the group represented by the formula (1) is bonded to a carbon atom.

2. The composition according to claim 1, wherein the block (A2) has two or more constituent units derived from an (α-substituted) acrylate having a group represented by the formula (1), and
a molar ratio of total constituent units of the block (A2) is greater than 0 mol % and 50 mol % or less with respect to total constituent units of the polymer (A).

3. The composition according to claim 2, wherein a molar ratio of total constituent units of the block (A2) is greater than 0 mol % and 20 mol % or less with respect to total constituent units of the polymer (A).

4. The composition according to claim 1, wherein the polymer (A) has a number average molecular weight of 2,000 or more and 10,000 or less.

5. The composition according to claim 1, wherein the block (A1) has a constituent unit derived from styrene or methyl methacrylate.

6. A polymer having a block (A1) and a block (A2), wherein the block (A1) has a constituent unit derived from at least one selected from the group consisting of styrene, a styrene derivative, and an (α-substituted) acrylate,
the block (A2) has two or more groups represented by the following formula (1): 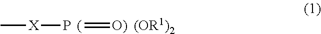
wherein, in the formula (1), X represents a single bond or an oxygen atom, and R¹ represents an alkyl group, and
wherein the group represented by the formula (1) is bonded to a carbon atom.

7. The polymer according to claim 6, wherein the block (A2) has two or more constituent units derived from an (α-substituted) acrylate having a group represented by the formula (1), and
a molar ratio of total constituent units of the block (A2) is greater than 0 mol % and 50 mol % or less with respect to total constituent units of the polymer (A).

8. The composition according to claim 2, wherein the polymer (A) has a number average molecular weight of 2,000 or more and 10,000 or less.

9. The composition according to claim 2, wherein the block (A1) has a constituent unit derived from styrene or methyl methacrylate.
